(19) United States
(12) Patent Application Publication
(10) Pub. No.: US 2023/0191367 A1
(43) Pub. Date: Jun. 22, 2023

(54) HEAVY METAL ADSORBENT AND METHOD FOR SIMULTANEOUS REMOVAL OF LEAD AND COPPER IN WASTEWATER USING THE SAME

(71) Applicant: GWANGJU INSTITUTE OF SCIENCE AND TECHNOLOGY, Gwangju (KR)

(72) Inventors: Kyoung Woong KIM, Gwangju (KR); Han Gyeol JEON, Seoul (KR)

(21) Appl. No.: 17/878,897

(22) Filed: Aug. 1, 2022

(30) Foreign Application Priority Data
Dec. 16, 2021 (KR) 10-2021-0181057
Jul. 5, 2022 (KR) 10-2022-0082304

(51) Int. Cl. B01J 20/24; B01J 20/30; C08B 37/00; C02F 1/28; C02F 1/66

(52) U.S. Cl. CPC B01J 20/24; B01J 20/3085; B01J 20/3021; C08B 37/0096; C02F 1/286; C02F 1/66; C02F 2101/20

(57) ABSTRACT

The present inventive concept relates to a heavy metal adsorbent, and more particularly, to an eco-friendly adsorbent including a biopolymer and being capable of simultaneously adsorbing and recovering lead and copper, and a method of preparing the same. According to the present inventive concept, since the present adsorbent exhibits a property of being insoluble in water due to the ester bond through the esterification reaction between xanthan gum which is one of the biopolymers, and citric acid, it solves the problem that recovery was impossible due to the water solubility of existing biopolymers; lead and copper can be effectively adsorbed and recovered in an aqueous solution; and the biopolymer and citric acid used in the adsorbent are bio-derived and biodegradable and therefore have eco-friendly advantages over existing adsorbents.

### CLAIM FOR PRIORITY

This application claims priority to Korean Patent Application No. 2021-0181057 filed on Dec. 16, 2021 and Korean Patent Application No. 2022-0082304 filed on Jul. 5, 2022 in the Korean Intellectual Property Office (KIPO), the entire contents of which are hereby incorporated by reference.

### BACKGROUND

### 1. Technical Field

The present inventive concept relates to a heavy metal adsorbent, and more particularly, to an eco-friendly adsorbent including a biopolymer and being capable of simultaneously adsorbing and recovering lead and copper, a method of preparing the same, and a method of simultaneously removing lead and copper in wastewater using the same.

### 2. Related Art

With continuous industrial development, the generation of heavy metal wastewater containing lead and copper is inevitable. Since the generated heavy metal is not biodegradable, it may adversely affect health for a long period of time when it enters the body of animals and humans, so proper treatment is required before discharge.

As methods for controlling heavy metals in such aqueous solutions, agglomeration/precipitation methods and adsorption methods are typically used. Among them, the coagulation/precipitation method is widely applied as it is known as a simple and economical method. However, when this method is applied, it is difficult to completely remove heavy metals, and there is a disadvantage in that a large amount of sludge generated after treatment must be treated. The adsorption method is a method of treating contaminants by adsorbing an adsorbate present in a liquid or solid phase onto the surface of a solid adsorbent, and an ion exchange resin is typically used when treating heavy metals in aqueous solutions.

FIG. 1 is a schematic diagram showing an adsorption mechanism through ion exchange of a synthetic ion exchange resin mainly used as a conventional heavy metal adsorbent.

As shown in FIG. 1, the synthetic ion exchange resin can effectively adsorb heavy metal ions by ion exchange action with heavy metal ions on the surface.

However, in the case of an ion exchange resin produced from petroleum, it is not environmentally friendly due to its recalcitrance and may cause environmental problems. Therefore, research using various materials is being actively conducted to develop an eco-friendly adsorbent.

Biopolymers are eco-friendly polymers derived from living organisms, and are widely used in food, cosmetic, pharmaceutical, petroleum industries and the like, and recently, they are being studied as a cement substitute in the field of construction engineering. In addition, the biopolymers have been reported to contain functional groups capable of adsorbing heavy metals and have been studied for treatment of heavy metals in aqueous solutions, but they are difficult to recover after treatment due to hydrophilicity of the biopolymer and there is difficulty in using them alone.

### SUMMARY

It is an objective of the present inventive concept to solve the above problem, and to provide a heavy metal adsorbent that is recoverable, insoluble, and includes a biopolymer.

Another objective of the present inventive concept is to provide a method of preparing a heavy metal adsorbent including the biopolymer.

In order to solve the above problems, one aspect of the present inventive concept provides an eco-friendly heavy metal adsorbent. The eco-friendly heavy metal adsorbent according to an embodiment of the present inventive concept is characterized in that it is an eco-friendly heavy metal adsorbent in the form of a porous body, in which at least one biopolymer moiety having a hydroxyl group and a carboxyl group and at least one citric acid moiety having a hydroxyl group and a carboxyl group are linked by an ester bond.

The biopolymer moiety is characterized as xanthan gum.

The eco-friendly heavy metal adsorbent can simultaneously adsorb lead and copper.

The eco-friendly heavy metal adsorbent can simultaneously adsorb lead and copper at pH 4 to 6.

The eco-friendly heavy metal adsorbent is characterized in that it is insoluble in water.

In the eco-friendly heavy metal adsorbent, the content of the citric acid moiety with respect to the biopolymer moiety may be 30 wt % or more and 100 wt % or less.

In addition, another aspect of the present inventive concept provides a method of preparing the eco-friendly heavy metal adsorbent. The method of preparing the eco-friendly heavy metal adsorbent includes preparing a citric acid solution (S10); and mixing a biopolymer with the citric acid solution and performing an esterification reaction to prepare an eco-friendly heavy metal adsorbent (S20).

The mixing of the citric acid solution with the biopolymer may be performed so that the content of the citric acid with respect to the biopolymer is 30 wt % or more and 100 wt % or less.

The esterification reaction may be performed at 150 to 190° C.

The method may further include pulverizing the eco-friendly heavy metal adsorbent prepared in step S20 and passing it through 20 to 40 mesh.

Furthermore, still another aspect of the present inventive concept provides a method of simultaneously removing lead and copper in wastewater using an eco-friendly heavy metal adsorbent including a biopolymer. The method of simultaneously removing lead and copper in wastewater includes adsorbing lead and copper onto the eco-friendly heavy metal adsorbent by inputting the eco-friendly heavy metal adsorbent into wastewater containing lead and copper (S100); and recovering the eco-friendly heavy metal adsorbent onto which the lead and copper are adsorbed after adsorption (S200).

The method may further include adjusting the hydrogen ion concentration (pH) of the wastewater containing lead and copper to 4 to 6 before step S100 in order to increase the adsorption performance of the adsorbent.

According to the present inventive concept, since the present adsorbent exhibits a property of being insoluble in water due to cross-linking through the esterification reaction between xanthan gum which is one of the biopolymers, and citric acid, it solves the problem that recovery was impossible due to the water solubility of existing biopolymers; and lead and copper can be effectively adsorbed and recovered in an aqueous solution. In addition, the biopolymer and citric acid used in the adsorbent are bio-derived and biodegradable, so they have an eco-friendly advantage compared to the existing adsorbent.

### BRIEF DESCRIPTION OF DRAWINGS

Example embodiments of the present inventive concept will become more apparent by describing in detail example embodiments of the present inventive concept with reference to the accompanying drawings, in which:

FIG. 1 is a schematic diagram showing an adsorption mechanism through ion exchange of a synthetic ion exchange resin mainly used as a conventional heavy metal adsorbent;

FIG. 2 is a schematic diagram showing an esterification reaction of a biopolymer according to an embodiment of the present inventive concept with citric acid;

FIGS. 3A and 3B are images showing (a) a biopolymer powder according to a comparative example of the present inventive concept and (b) heavy metal adsorbent particles in which a biopolymer moiety and a citric acid moiety are linked by an ester bond according to an example;

FIGS. 4A and 4B are scanning electron microscope (SEM) images showing (a) a biopolymer powder according to a comparative example of the present inventive concept and (b) heavy metal adsorbent particles in which a biopolymer moiety and a citric acid moiety are linked by an ester bond according to an example;

FIG. 5 is a graph obtained by FT-IR analysis of (a) a biopolymer powder according to a comparative example of the present inventive concept and (b) particles in which a biopolymer moiety and a citric acid moiety are linked by an ester bond according to an example;

FIGS. 6A and 6B are graphs showing the results of an adsorption rate experiment for lead and copper using particles in which a biopolymer moiety and a citric acid moiety are linked by an ester bond according to an embodiment of the present inventive concept;

FIGS. 7A, 7B, 7C and 7D are SEM-EDX images showing the adsorption of (a) lead and (b) copper on particles in which a biopolymer moiety and a citric acid moiety are linked by an ester bond according to an embodiment of the present inventive concept;

FIGS. 8A and 8B are graphs showing the results of an adsorption isotherm experiment for (a) lead and (b) copper using particles in which a biopolymer moiety and a citric acid moiety are linked by an ester bond according to an embodiment of the present inventive concept;

FIGS. 9A and 9B are graphs showing the change in adsorption amount of (a) lead and (b) copper according to a change in solution pH for particles in which a biopolymer moiety and a citric acid moiety are linked by an ester bond according to an embodiment of the present inventive concept;

FIGS. 10A and 10B are graphs showing the change in adsorption amount of (a) lead and (b) copper according to the content of citric acid for particles in which a biopolymer moiety and a citric acid moiety are linked by an ester bond according to an embodiment of the present inventive concept;

FIGS. 11A and 11B are graphs showing the change in adsorption amount of (a) lead and (b) copper according to the reaction temperature during the esterification reaction for the particles in which a biopolymer moiety and a citric acid moiety are linked by an ester bond according to an embodiment of the present inventive concept;

FIGS. 12A and 12B are graphs showing the change in adsorption amount of (a) lead and (b) copper according to the size of particles in which a biopolymer moiety and a citric acid moiety are linked by an ester bond according to an embodiment of the present inventive concept; and

FIGS. 13A and 13B are graphs showing the change in adsorption amount of (a) lead and (b) copper according to the size and input amount of particles in which a biopolymer moiety and a citric acid moiety are linked by an ester bond according to an embodiment of the present inventive concept.

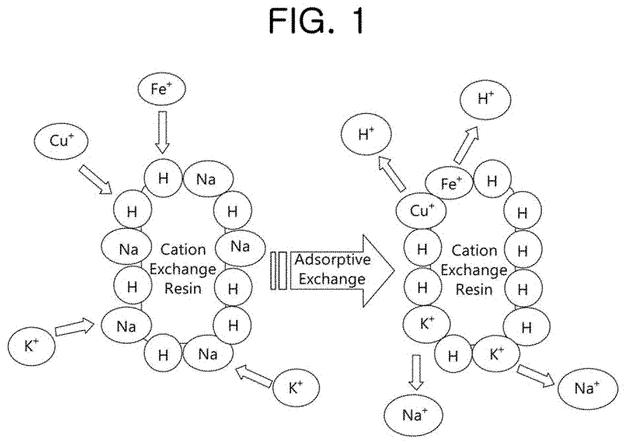

### DESCRIPTION OF EXAMPLE EMBODIMENTS

While the present inventive concept is susceptible to various modifications and variations, specific embodiments thereof are illustrated by the drawings and will be described in detail below. However, it is not intended to limit the inventive concept to the particular form disclosed, but rather the inventive concept includes all modifications, equivalents and substitutions consistent with the spirit of the inventive concept as defined by the claims.

Although the terms first, second, etc. may be used to describe various elements, components, regions, layers and/or regions, it will be understood that such elements, components, regions, layers and/or regions should not be limited by such terms.

[Eco-Friendly Heavy Metal Adsorbent]

One aspect of the present inventive concept provides an eco-friendly heavy metal adsorbent including a biopolymer.

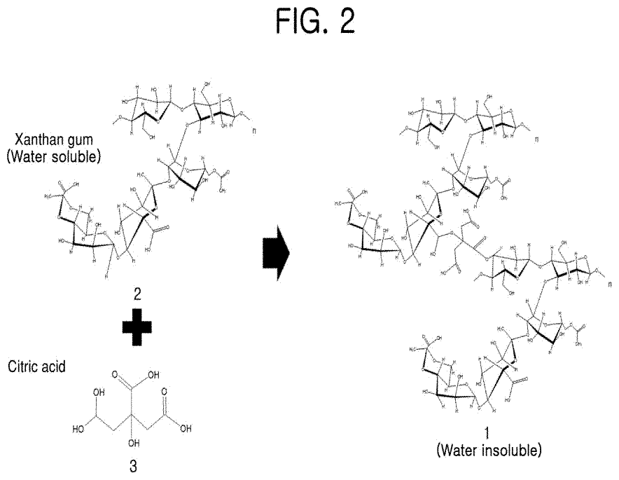

FIG. 2 is a schematic diagram showing an esterification reaction of a biopolymer according to an embodiment of the present inventive concept with citric acid.

Referring to FIG. 2, the eco-friendly heavy metal adsorbent according to an embodiment of the present inventive concept is characterized in that it is an eco-friendly heavy metal adsorbent in the form of a porous body in which at least one biopolymer moiety having a hydroxyl group and a carboxyl group, and at least one citric acid moiety having a hydroxyl group and a carboxyl group are linked by ester bonds through an esterification reaction of the hydroxyl groups and carboxyl groups of the biopolymer and citric acid.

In this case, as the biopolymer, a biopolymer known in the art may be used, and as an example, starch, chitosan, beta glucan, xanthan gum, etc. may be used, but preferably xanthan gum may be used. The xanthan gum is easily available, is inexpensive, and is characterized in that it is easy to adsorb heavy metals due to the presence of a large number of hydroxyl groups and carboxyl groups in the polymer, and it is insoluble in water through an ester bond through an esterification reaction with the hydroxyl groups or carboxyl groups of citric acid, so that it can be recovered after adsorbing heavy metals in water.

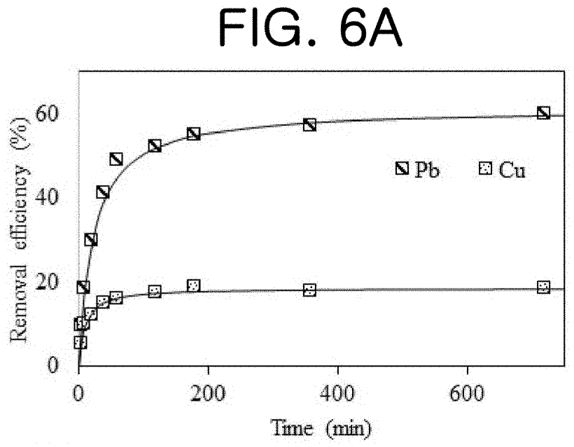

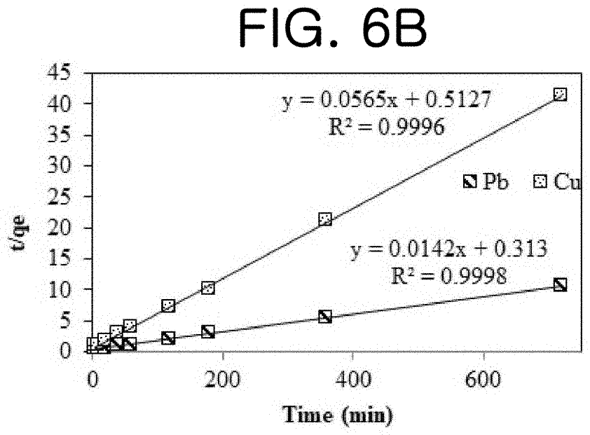

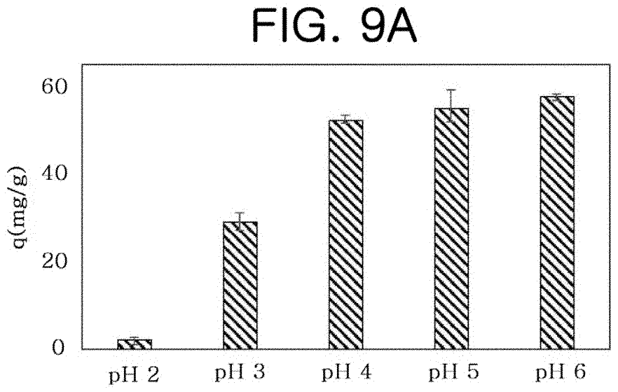

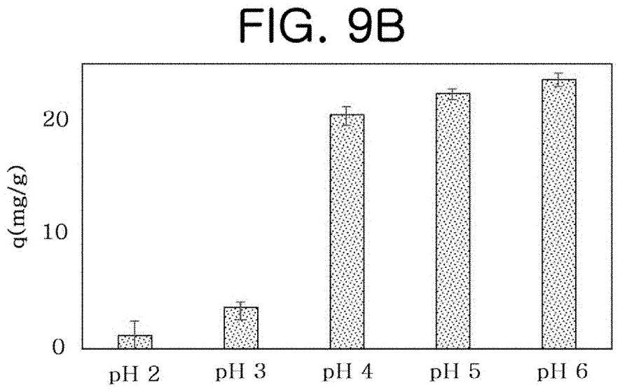

According to the heavy metal adsorption experiment result according to the experimental example to be described later, the eco-friendly heavy metal adsorbent simultaneously adsorbed lead and copper, as shown in FIG. 6. In particular, as shown in FIG. 9 through an adsorption amount experiment according to pH, it was found that lead and copper were simultaneously adsorbed with high adsorption efficiency at pH 4 to 6. Therefore, the adsorbent according to the present inventive concept is eco-friendly because it is prepared using a biopolymer and citric acid derived from nature, can adsorb lead and copper simultaneously, and is insoluble in water and thus can be recovered, so it is useful as an adsorbent for removing heavy metals in wastewater.

In the eco-friendly heavy metal adsorbent, the content of the citric acid moiety to the biopolymer moiety is preferably 30 wt % or more and 100 wt % or less, and when the citric acid moiety content is less than 30 wt %, there is a problem that the adsorption amount of the prepared adsorbent is reduced.

In the eco-friendly heavy metal adsorbent, the particle size of the adsorbent also affects the heavy metal adsorption amount, particularly the copper adsorption amount, and it was found that the smaller the particle size of the adsorbent, the higher the copper adsorption amount. However, when a particle size of the adsorbent is too small, since it is difficult to recover after heavy metal adsorption, as the particle size of the adsorbent, it is preferred to select a 20-40 mesh pass size (about 420-840 μm) which is similar to the activated carbon particle size that was conventionally used as an adsorbent.

In addition, another aspect of the present inventive concept provides a method of preparing the eco-friendly heavy metal adsorbent.

The method of preparing the eco-friendly heavy metal adsorbent includes preparing a citric acid solution (S10); and

mixing a biopolymer with the citric acid solution and performing an esterification reaction to prepare an eco-friendly heavy metal adsorbent (S20).

Hereinafter, the method of preparing the eco-friendly heavy metal adsorbent according to the present inventive concept will be described in detail step by step.

First, step S10 is a step of preparing a citric acid solution.

The citric acid solution can be prepared by completely dissolving citric acid in water, and it is preferable to prepare a solution so that the content of citric acid is 30 wt % or more and 100 wt % or less relative to the biopolymer to be described later.

Next, step S20 is a step of preparing an adsorbent by reacting citric acid with the biopolymer.

Specifically, a biopolymer, for example, xanthan gum, is added to the prepared citric acid solution and stirred to form a uniform mixed solution with a homogenizer or the like.

The stirred mixed solution is subjected to an esterification reaction at 150 to 190° C. to form an adsorbent product in which an ester bond is formed.

The method may further include pulverizing the product using a mortar or the like and passing it through 20 to 40 mesh.

Since the product passed through 20 to 40 mesh is insoluble in water, washing with water to remove impurities and drying may be performed.

The dried product may be sieved again to 20 to 40 mesh, and the product passing through 20 to 40 mesh may be separated and used as an adsorbent.

According to the present inventive concept, since the present adsorbent exhibits a property of being insoluble in water due to the ester bond through the esterification reaction between xanthan gum, which is one of the biopolymers, and citric acid, it solves the problem that recovery was impossible due to the water solubility of existing biopolymers; and lead and copper can be effectively adsorbed and recovered in an aqueous solution. In addition, the biopolymer and citric acid used in the adsorbent are bio-derived and biodegradable, so they have an eco-friendly advantage compared to the existing adsorbent.

[Method of Simultaneously Removing Lead and Copper in Wastewater Using Eco-Friendly Heavy Metal Adsorbent]

Furthermore, still another aspect of the present inventive concept provides a method of simultaneously removing lead and copper in wastewater using an eco-friendly heavy metal adsorbent including a biopolymer.

The method of simultaneously removing lead and copper in the wastewater includes adsorbing lead and copper onto the eco-friendly heavy metal adsorbent by inputting the eco-friendly heavy metal adsorbent into wastewater containing lead and copper (S100); and

recovering the eco-friendly heavy metal adsorbent onto which the lead and copper are adsorbed after adsorption (S200).

Hereinafter, the method of simultaneously removing lead and copper in wastewater using an eco-friendly heavy metal adsorbent according to the present inventive concept will be described in detail step by step.

First, step S100 is a step of inputting the eco-friendly heavy metal adsorbent according to the present inventive concept into wastewater.

The heavy metal adsorbent is preferably input in an amount of 1 g/L or more. When the above amount is input, about 99% or more of lead and copper can be removed from wastewater having a lead ion and copper ion concentration of 10 mg/L or less.

The adsorption reaction time is preferably 1 to 2 hours, which is when the heavy metal adsorbent can reach 80% of the maximum adsorption amount. When out of the above range, if the reaction time is too short, there is a possibility that the adsorption reaction may not be sufficiently performed, and if the maximum limit is exceeded, it may not be economical.

Also, the method may further include adjusting the hydrogen ion concentration (pH) of the wastewater containing lead and copper to 4 to 6 before step S100 in order to increase the adsorption performance of the adsorbent.

Next, step S200 is a step of recovering the eco-friendly heavy metal adsorbent onto which the lead and copper are adsorbed after adsorption.

Since the eco-friendly heavy metal adsorbent is insoluble in water, it can be recovered through a filter or the like after adsorbing lead and copper. In addition, wastewater from which lead and copper have been removed due to the eco-friendly heavy metal adsorbent may be discharged.

Hereinafter, preferred examples according to the present inventive concept will be described in more detail with reference to the accompanying drawings in order to explain the present inventive concept in more detail. As such, the present inventive concept is not limited to the Experimental Examples described herein, and may be embodied in other forms.

### EXAMPLES

### Preparation Example 1: Preparation of Eco-Friendly Heavy Metal Adsorbent in which Biopolymer and Citric Acid are Combined

First, 1.2 g of citric acid was completely dissolved in 100 ml of distilled water to prepare a citric acid solution. Then, 4 g of xanthan gum as a biopolymer was added to the citric acid solution and mixed at 13,000 rpm for 2 minutes using a homogenizer.

After the esterification reaction was performed by heating the mixed solution in a dryer under a 160° C. condition for 3 hours, the product cross-linked by the reaction was dried again under a 70° C. condition in a dryer for about 21 hours.

The product was pulverized using a mortar, classified by particle size using a mesh sieve, and only particles that passed through a 20 to 40 mesh sieve were recovered.

The recovered product was washed with distilled water for 24 hours. During washing, the product appeared insoluble in distilled water. After washing, the product was dried in a dryer for 24 hours to remove unreacted materials through a complete drying process and a purified heavy metal adsorbent was obtained.

In order to measure the physical and chemical properties of the prepared heavy metal adsorbent, visual observation, scanning microscope observation and FT-IR analysis were performed.

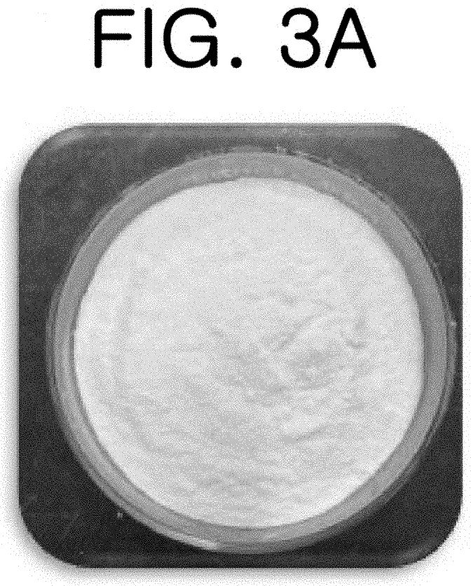

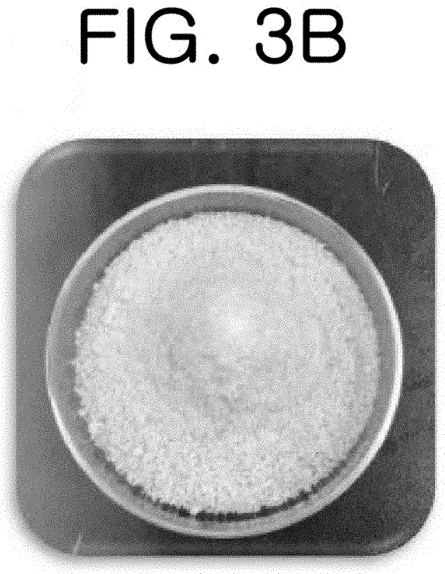

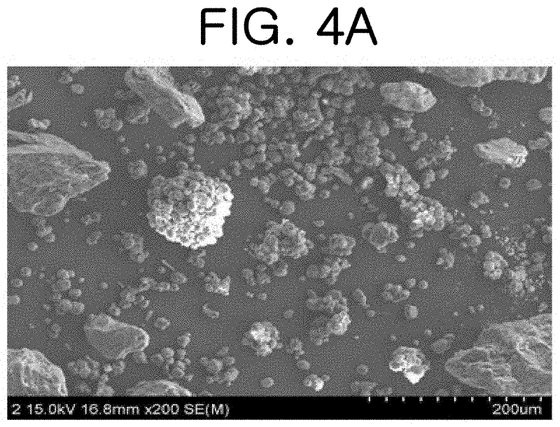

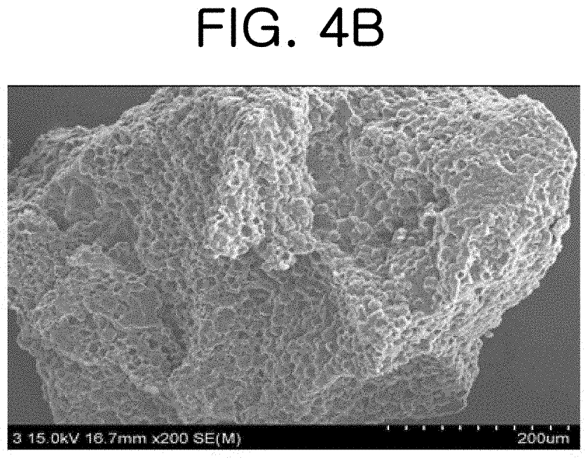

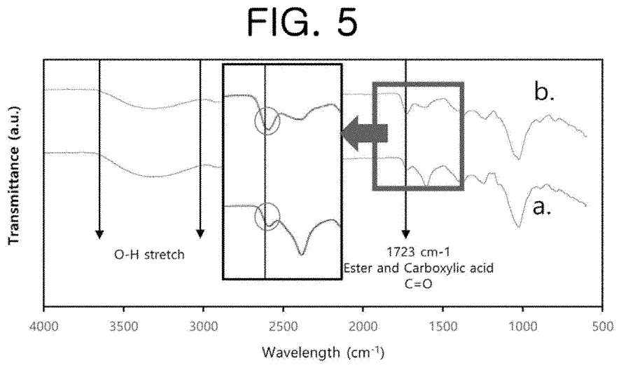

Specifically, the prepared adsorbent powder and the pre-production biopolymer powder were visually compared and shown in FIG. 3, observed under a scanning microscope and shown in FIG. 4, and FT-IR analysis was performed and the results are shown in FIG. 5.

FIGS. 3A and 3B are images showing (a) a biopolymer powder according to a comparative example of the present inventive concept and (b) heavy metal adsorbent particles in which a biopolymer moiety and a citric acid moiety are linked by an ester bond according to an example.

As shown in FIGS. 3A and 3B, it can be seen that the biopolymer powder of FIG. 3a has a white and very fine powder form, but the particle size of the adsorbent particles generated after the reaction of FIG. 3b becomes relatively coarse due to agglomeration of the particles.

FIGS. 4A and 4B are scanning electron microscope (SEM) images showing (a) a biopolymer powder according to a comparative example of the present inventive concept and (b) heavy metal adsorbent particles in which a biopolymer moiety and a citric acid moiety are linked by an ester bond according to an example.

As shown in FIGS. 4A and 4B, compared to the biopolymer powder of FIG. 4A, it was found that the adsorbent particles of FIG. 4B agglomerated due to the reaction of the biopolymer and citric acid, and the particle size became relatively coarse, and the surface has a large distribution of pores for adsorption.

FIG. 5 is a graph obtained by FT-IR analysis of (a) a biopolymer powder according to a comparative example of the present inventive concept and (b) heavy metal adsorbent particles in which a biopolymer moiety and a citric acid moiety are linked by an ester bond according to an example.

As shown in FIG. 5, according to the FT-IR analysis result, in the case of (a) xanthan gum as a biopolymer and (b) the material produced after the esterification reaction of the biopolymer with citric acid, the hydroxyl group and ester group and carboxyl group at 1723 cm⁻¹ were observed. However, it was observed that the peak of the ester group and the carboxyl group increased at 1723 cm⁻¹ after crosslinking, which is thought to be due to the carboxylic acid contained in citric acid, and since the carboxylic acid is known to be a functional group that easily adsorbs heavy metals, this increases the adsorption amount of heavy metals and may relate to being insolubilized in an aqueous solution.

### Experimental Example 1: Adsorption Experiment of Eco-Friendly Heavy Metal Adsorbent According to the Present Inventive Concept

In order to investigate the heavy metal adsorption capacity of the eco-friendly heavy metal adsorbent according to the present inventive concept, the following experiment was performed.

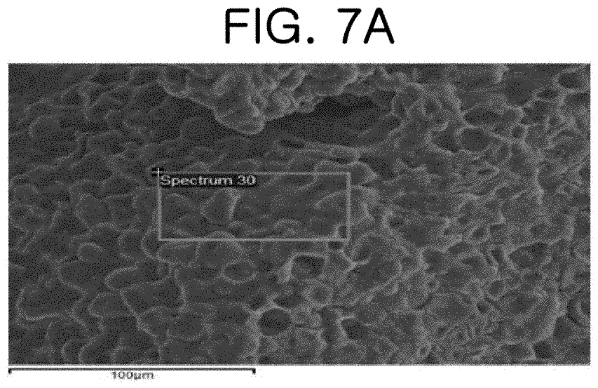

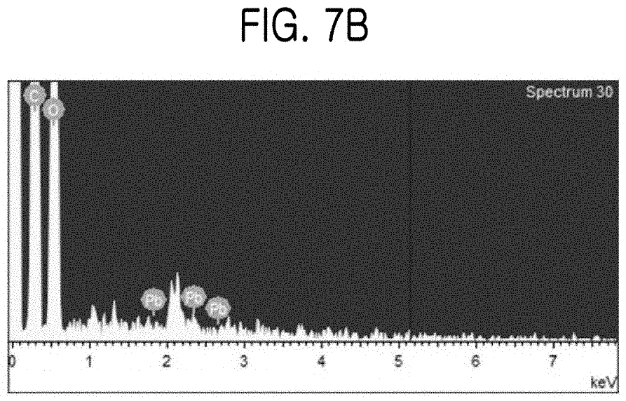

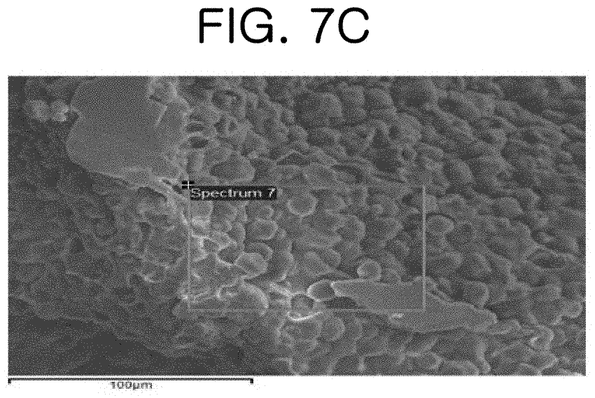

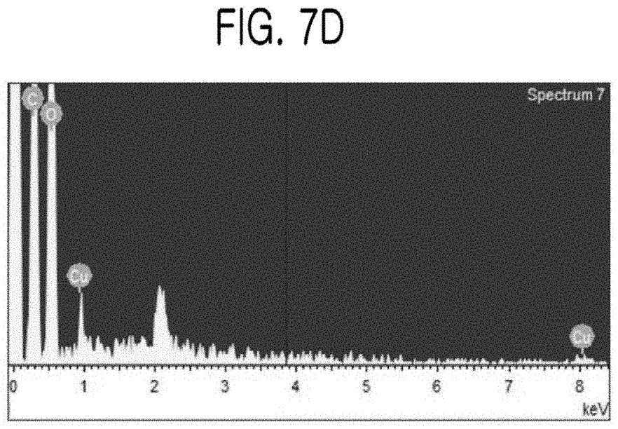

Specifically, 1 L of lead and copper artificial wastewater was prepared under conditions of 50 mg/L and pH 5 using Pb(NO₃)₂ and Cu(NO₃)₂·3H₂O, respectively, and after placing the artificial wastewater and particles including the biopolymer prepared in Preparation Example 1 in a 1 L beaker, stirring was performed using a stirrer at laboratory temperature conditions (23-25° C.) for 12 hours, and about 3 ml or less was aliquoted at regular intervals. The aliquoted solution was diluted and the concentration was measured using ICP-OES, and after the concentration measurement was completed, the particles containing the biopolymer were taken out and the composition of the surface was analyzed by SEM-EDX, and the results are shown in FIGS. 6 and 7.

FIGS. 6A and 6B are graphs showing the results of an adsorption rate experiment for lead and copper using heavy metal adsorbent particles in which a biopolymer moiety and a citric acid moiety are linked by an ester bond according to an embodiment of the present inventive concept.

As shown in FIG. 6A, according to the results of the adsorption rate experiment, when the particles in which the biopolymer and citric acid are combined according to the present inventive concept are added to artificial wastewater, it can be seen that 80% or more of both lead and copper are adsorbed within 60 minutes and removed from the wastewater, and lead is almost at equilibrium in about 6 hours and copper in about 3 hours.

In addition, as shown in FIG. 6B, the adsorption rates of lead and copper were both found to follow a similar second-order reaction model.

FIGS. 7A through 7D are SEM-EDX images showing the adsorption of (a) lead and (b) copper on heavy metal adsorbent particles in which a biopolymer moiety and a citric acid moiety are linked by an ester bond according to an embodiment of the present inventive concept after the adsorption rate experiment.

As shown in FIGS. 7A through 7B, after the adsorption rate experiment, when the surface of the particle in which the biopolymer and citric acid were combined according to the present inventive concept was analyzed by SEM-EDX, it was confirmed that lead and copper components were detected on the particle surface, whereby it was found that the particle in which the biopolymer and the citric acid are combined according to the present inventive concept simultaneously adsorbs lead and copper in the wastewater.

### Experimental Example 2: Adsorption Isothermal Experiment of Eco-Friendly Heavy Metal Adsorbent According to the Present Inventive Concept

An adsorption isothermal experiment was performed on the eco-friendly heavy metal adsorbent according to the present inventive concept as follows.

Specifically, lead and copper artificial wastewater was prepared under conditions of 0 to 400 mg/L and pH 5 using Pb(NO₃)₂ and Cu(NO₃)₂·3H₂O, respectively, and then 100 ml of the artificial wastewater and 0.05 g of adsorbent were input into a 300 ml flask.

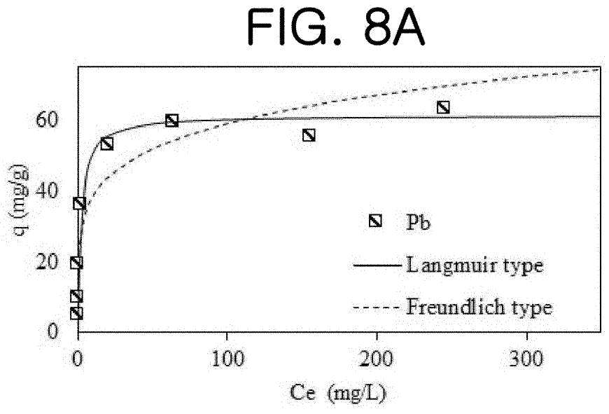

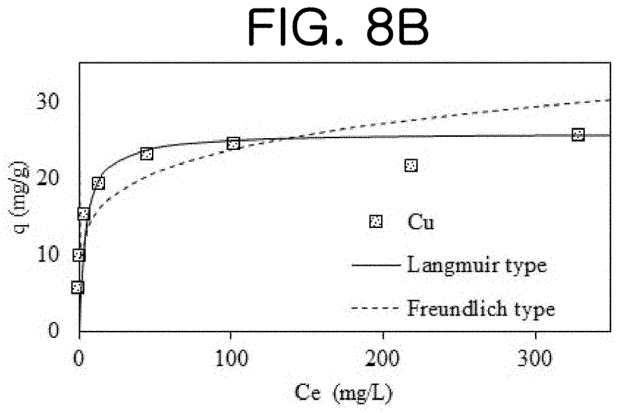

Each sample was shaken under conditions of 150 rpm and 25° C. for 12 hours in a thermostatic shaker. Thereafter, filtration with a syringe filter was performed, the concentration was measured using ICP-OES to derive adsorption data, which was then applied to Freundlich and Langmuir adsorption isothermal models, and the results are shown in Tables 1 and 2 and FIG. 8 below.

FIGS. 8A and 8B are graphs showing the experimental results of an adsorption isotherm for (a) lead and (b) copper using heavy metal adsorbent particles in which a biopolymer moiety and a citric acid moiety are linked by an ester bond according to an embodiment of the present inventive concept.

Table 1 shows the equation and parameters of the Langmuir adsorption isothermal model, and Table 2 shows the equation and parameters of the Freundlich adsorption isothermal model.

TABLE 1
Langmuir

| | a (mg/L) | b (L/mg) | RL | Equation | r² |
|---|---|---|---|---|---|
| Pb | 59.1716 | 0.0006 | 0.9944 | y = 0.0163x + 0.0346 | 0.9950 |
| Cu | 20.8333 | 0.006 | 0.9427 | y = 0.0385x + 0.1579 | 0.9986 |

TABLE 2
Freundlich

| | a (mg/L) | b (L/mg) | Equation | r² |
|---|---|---|---|---|
| Pb | 1.5286 | 0.1843 | y = 0.1843x + 1.404 | 0.9710 |
| Cu | 1.5623 | 0.1939 | y = 0.1939x + 0.9874 | 0.9618 |

As shown in Table 1, Table 2 and FIGS. 8A and 8B, as a result of applying the adsorption isothermal experiment results to each model, lead and copper adsorption using heavy metal adsorbent particles in which a biopolymer moiety and a citric acid moiety are linked by an ester bond according to the present inventive concept was found to fit the Langmuir model. The Langmuir model assumes that the adsorbent adsorbs as a monolayer on the surface of the adsorbent with a uniform energy distribution at equilibrium.

At this time, the maximum adsorption amounts of lead and copper were 61.3 mg/g and 26.0 mg/g, respectively.

### Experimental Example 3: Change in Adsorption Capacity According to pH of Eco-Friendly Heavy Metal Adsorbent According to the Present Inventive Concept

In order to investigate the change in the adsorption capacity according to the pH of the eco-friendly heavy metal adsorbent according to the present inventive concept, the following experiment was performed.

Specifically, 50 mg/L of lead and copper artificial wastewater was prepared using Pb(NO₃)₂ and Cu(NO₃)₂·3H₂O, respectively, and then 100 ml of the artificial wastewater and 0.05 g of adsorbent were input into a 300 ml flask.

After adjusting the pH to between 2 and 6, each sample was shaken under conditions of 150 rpm and 25° C. for 12 hours in a thermostatic shaker. Thereafter, it was filtered through a syringe filter and the concentration was measured using ICP-OES to derive adsorption data, and the adsorption amount according to the change in pH was measured for lead and copper, respectively, and is shown in FIG. 9.

FIGS. 9A and 9B are graphs showing the change in adsorption amount of (a) lead and (b) copper according to a change in solution pH for heavy metal adsorbent particles in which a biopolymer moiety and a citric acid moiety are linked by an ester bond according to an embodiment of the present Inventive concept.

As shown in FIGS. 9A and 9B, according to the results of the experiment, although it was confirmed that the amounts of lead and copper adsorbed by the particles in which the biopolymer and citric acid were combined according to the present inventive concept were not significantly changed to 52 to 58 mg/g and 21 to 24 mg/g, respectively, under the condition of pH 4 to 6, the amounts of lead and copper adsorbed were extremely low at 29 mg/g and 4 mg/g, respectively, from the condition of pH 3, and adsorption was not performed well by showing 2 mg/g and 1 mg/g, respectively, under the pH 2 condition.

Therefore, when the heavy metal adsorbent particles in which a biopolymer moiety and a citric acid moiety are linked by an ester bond according to the present inventive concept are used as the adsorbent, it can be seen that the pH conditions for adsorption of lead and copper are preferably pH 4 to 6.

### Experimental Example 4: Change in Adsorption Capacity According to Citric Acid Content when Preparing Eco-Friendly Heavy Metal Adsorbent According to the Present Inventive Concept

For the eco-friendly heavy metal adsorbent according to the present inventive concept, the following experiment was performed to examine the change in adsorption capacity of the prepared adsorbent according to the content of citric acid as a reactant during the esterification reaction.

Specifically, adsorbents were prepared by varying the content of citric acid to 5%, 10%, 20%, 30%, 50% and 100 wt % relative to the biopolymer when preparing a citric acid solution, 0.1 g/L of the adsorbents were input under a 10 mg/L condition of lead and copper artificial wastewater.

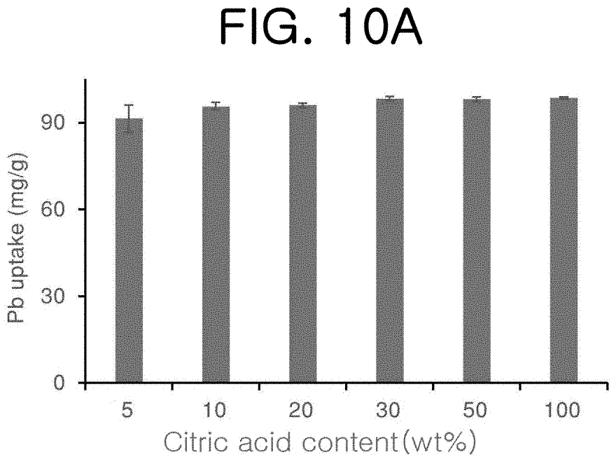

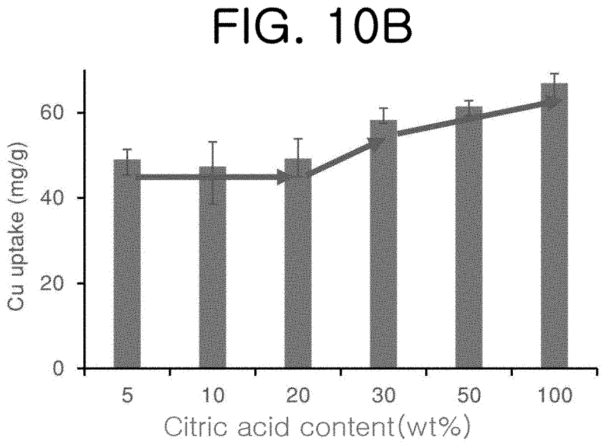

Each sample was shaken under conditions of 150 rpm and 25° C. for 12 hours in a thermostatic shaker. Thereafter, it was filtered through a syringe filter and the concentration was measured using ICP-OES to derive adsorption data, and the adsorption amount according to the content of citric acid for lead and copper was measured and shown in FIG. 10.

FIG. 10 is a graph showing the change in adsorption amount of (a) lead and (b) copper according to the content of citric acid for heavy metal adsorbent particles in which a biopolymer moiety and a citric acid moiety are linked by an ester bond according to an embodiment of the present inventive concept.

As shown in FIGS. 10A and 10B, according to the experimental results, in the case of lead, it was found that almost all of the lead is adsorbed when heavy metal adsorbent particles in which a biopolymer moiety and a citric acid moiety are linked by an ester bond according to the present inventive concept were input, without significant differences according to the content of citric acid.

However, in the case of copper, there was a change in the adsorption amount according to the content of citric acid, and specifically, it was found that the adsorption amount of copper increased when the content of citric acid was 30 wt % or more. Therefore, when the heavy metal adsorbent particles in which a biopolymer moiety and a citric acid moiety are linked by an ester bond according to the present inventive concept are used as the adsorbent, it can be seen that the content of citric acid used as a reactant, for effective simultaneous adsorption of lead and copper is preferably at least 30 wt % relative to the biopolymer.

### Experimental Example 5: Change in Adsorption Capacity According to Reaction Temperature when Preparing Eco-Friendly Heavy Metal Adsorbent According to the Present Inventive Concept

For the eco-friendly heavy metal adsorbent according to the present inventive concept, the following experiment was performed to examine the change in adsorption capacity of the prepared adsorbent according to the reaction temperature during the esterification reaction.

Specifically, 0.1 g/L of the adsorbents, which were prepared by changing the reaction temperature to 70 to 190° C. in the esterification reaction of the citric acid solution and the biopolymer, were input under a condition of 10 mg/L of lead and copper artificial wastewater.

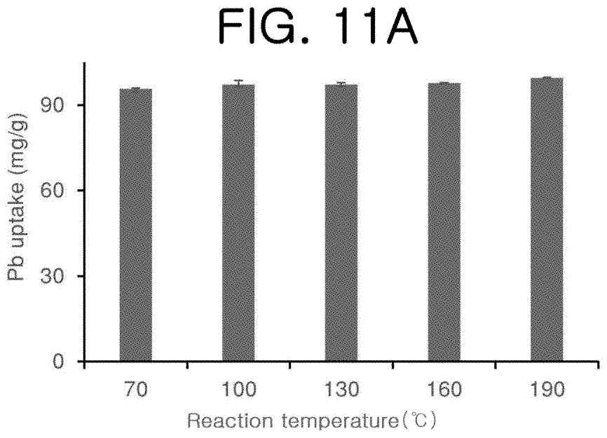

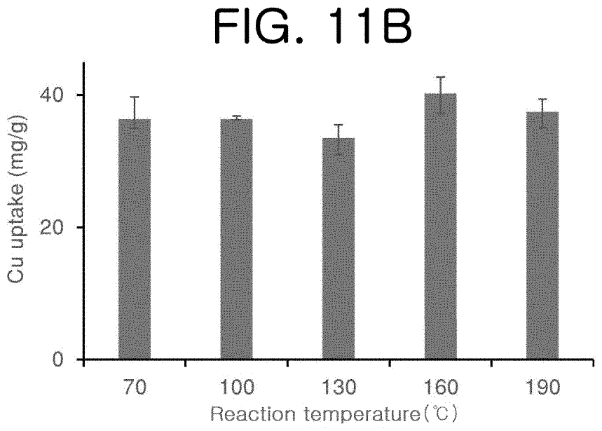

Each sample was shaken under conditions of 150 rpm and 25° C. for 12 hours in a thermostatic shaker. Thereafter, it was filtered through a syringe filter and the concentration was measured using ICP-OES to derive adsorption data, and the adsorption amount according to the reaction temperature was measured for lead and copper, respectively, and is shown in FIG. 11.

FIGS. 11A and 11B are graphs showing the change in adsorption amount of (a) lead and (b) copper according to the reaction temperature for heavy metal adsorbent particles in which a biopolymer moiety and a citric acid moiety are linked by an ester bond according to an embodiment of the present inventive concept.

As shown in FIGS. 11A and 11B, according to the experimental results, in the case of lead, it was found that almost all of the lead is adsorbed when heavy metal adsorbent particles in which a biopolymer moiety and a citric acid moiety are linked by an ester bond according to the present inventive concept were input, regardless of the reaction temperature.

However, in the case of copper, there was a change in the adsorption amount depending on the reaction temperature during preparation, specifically, the adsorbed amount of copper was relatively small, i.e., less than 40 mg/g when the reaction temperature was 130° C. or lower, but when the reaction temperature was 160° C., the adsorption amount of the copper was increased to about 40 mg/g, and when the reaction temperature increased to 190° C., the adsorption amount of copper again decreased. Therefore, when the heavy metal adsorbent particles in which a biopolymer moiety and a citric acid moiety are linked by an ester bond according to the present inventive concept are used as the adsorbent, the reaction temperature is preferably 130 to 190° C., specifically, 150 to 190° C. for effective simultaneous adsorption of lead and copper.

### Experimental Example 6: Change in Adsorption Capacity According to Particle Size of Eco-Friendly Heavy Metal Adsorbent According to the Present Inventive Concept

For the eco-friendly heavy metal adsorbent according to the present inventive concept, the following experiment was performed to investigate the change in adsorption capacity according to the particle size of the adsorbent.

Specifically, for the adsorbent prepared in Preparation Example 1, after pulverizing using a mortar and classifying the particles using a mesh sieve, 0.1 g/L of the adsorbents were input under a condition of 10 mg/L of lead and copper artificial wastewater.

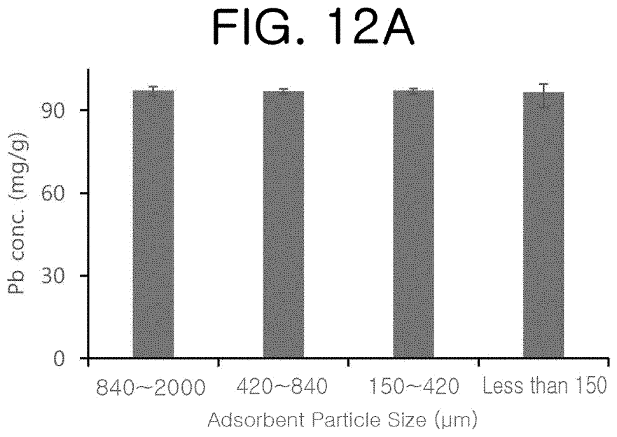

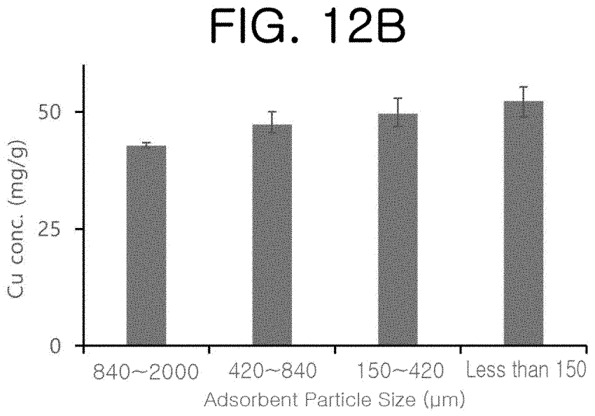

Each sample was shaken under conditions of 150 rpm and 25° C. for 12 hours in a thermostatic shaker. Thereafter, it was filtered through a syringe filter and the concentration was measured using ICP-OES to derive adsorption data, and the adsorption amount according to the particle size of adsorbent for lead and copper was measured and shown in FIG. 12.

FIGS. 12A and 12B are graphs showing the change in adsorption amount of (a) lead and (b) copper according to the size of heavy metal adsorbent particles in which a biopolymer moiety and a citric acid moiety are linked by an ester bond according to an embodiment of the present inventive concept.

As shown in FIGS. 12A and 12B, according to the experimental results, in the case of lead, it was found that almost all of the lead is adsorbed when heavy metal adsorbent particles in which a biopolymer moiety and a citric acid moiety are linked by an ester bond according to the present inventive concept were input, regardless of the particle size of the adsorbent.

However, in the case of copper, the adsorption amount changed depending on the particle size of the adsorbent, specifically, the adsorption amount of copper was found to be low when the particle size was 840 μm or more, and as it became smaller than 840 μm, an aspect in which the adsorption amount of copper increased was shown. However, when the particle size of the adsorbent becomes too small, recovery is difficult, and therefore considering recovery after adsorption, a particle size of 420 to 840 μm similar to the general activated carbon particle size (20 to 40 mesh pass size) can be used.

### Experimental Example 7: Change in Adsorption Capacity According to Input Amount of Eco-Friendly Heavy Metal Adsorbent According to the Present Inventive Concept

For the eco-friendly heavy metal adsorbent according to the present inventive concept, the following experiment was performed to investigate the change in adsorption capacity according to the input amount of the adsorbent.

Specifically, for the adsorbent prepared in Preparation Example 1, after pulverizing using a mortar and classifying particles by using a mesh sieve, 0.1 g/L to 1 g/L of the adsorbents were input under a condition of 10 mg/L of lead and copper artificial wastewater.

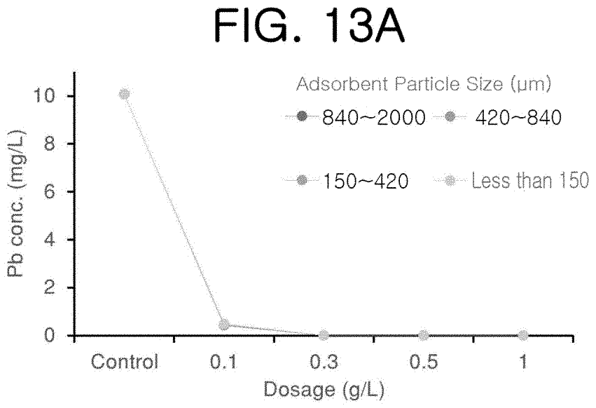

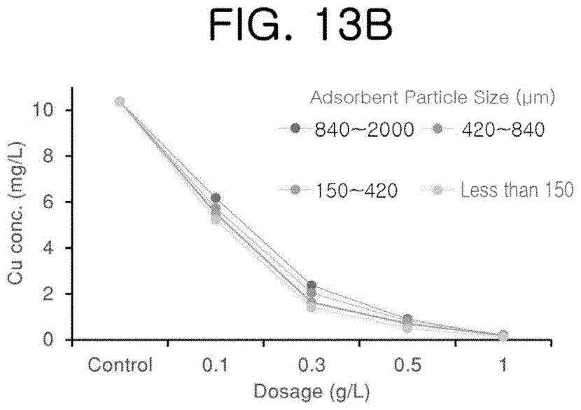

Each sample was shaken under conditions of 150 rpm and 25° C. for 12 hours in a thermostatic shaker. Thereafter, it was filtered through a syringe filter and the concentration was measured using ICP-OES to derive adsorption data, and the adsorption amount according to the input amount of adsorbent for lead and copper was measured and shown in FIG. 13.

FIGS. 13A and 13B are graphs showing the change in adsorption amount of (a) lead and (b) copper according to the size and input amount of heavy metal adsorbent particles in which a biopolymer moiety and a citric acid moiety are linked by an ester bond according to an embodiment of the present inventive concept.

As shown in FIGS. 13A and 13B, according to the experimental results, it was found that the removal rate of lead and copper increases as the input amount increases regardless of the particle size of the adsorbent according to the present inventive concept, and that both lead and copper are removed when 1 g/L of the adsorbent is input.

Therefore, it can be seen that when particles in which the biopolymer and citric acid were combined according to the present inventive concept are used as an adsorbent, the amount of the adsorbent is preferably 1 g/L or more for effective simultaneous adsorption of lead and copper.

Meanwhile, the embodiments of the present inventive concept disclosed in the present specification and drawings are merely presented as specific examples to aid understanding, and are not intended to limit the scope of the present inventive concept. It will be apparent to those skilled in the art that other modifications based on the technical concept of the present inventive concept can be implemented in addition to the embodiments disclosed herein.

1. An eco-friendly heavy metal adsorbent in the form of a porous body, in which at least one biopolymer moiety having a hydroxyl group and a carboxyl group and at least one citric acid moiety having a hydroxyl group and a carboxyl group are linked by an ester bond.

2. The eco-friendly heavy metal adsorbent of claim 1, wherein the biopolymer moiety is xanthan gum.

3. The eco-friendly heavy metal adsorbent of claim 1, wherein the eco-friendly heavy metal adsorbent simultaneously adsorbs lead and copper.

4. The eco-friendly heavy metal adsorbent of claim 1, wherein the eco-friendly heavy metal adsorbent simultaneously adsorbs lead and copper at a pH of 4 to 6.

5. The eco-friendly heavy metal adsorbent of claim 1, wherein the eco-friendly heavy metal adsorbent is insoluble in water.

6. The eco-friendly heavy metal adsorbent of claim 1, wherein the content of the citric acid moiety with respect to the biopolymer moiety is 30 wt % or more and 100 wt % or less.

7. A method of preparing an eco-friendly heavy metal adsorbent, comprising:
preparing a citric acid solution (S10); and
mixing a biopolymer with the citric acid solution and performing an esterification reaction to prepare an eco-friendly heavy metal adsorbent (S20).

8. The method of claim 7, wherein the mixing of the citric acid solution with the biopolymer is performed so that the content of the citric acid with respect to the biopolymer is 30 wt % or more and 100 wt % or less.

9. The method of claim 7, wherein the esterification reaction is performed at 150 to 190° C.

10. The method of claim 7, further comprising pulverizing the prepared eco-friendly heavy metal adsorbent and passing it through 20 to 40 mesh.

11. A method of simultaneously removing lead and copper in wastewater using an eco-friendly heavy metal adsorbent, comprising:
inputting the eco-friendly heavy metal adsorbent of claim 1 into wastewater containing lead and copper to absorb lead and copper onto the eco-friendly heavy metal adsorbent (S100); and
recovering the eco-friendly heavy metal adsorbent onto which the lead and copper are adsorbed after adsorption (S200).

12. The method of claim 11, further comprising adjusting the hydrogen ion concentration (pH) of the wastewater containing lead and copper to 4 to 6 before step S100 in order to increase the adsorption performance of the adsorbent.
